(19) United States
(12) Patent Application Publication
(10) Pub. No.: US 2014/0242377 A1
(43) Pub. Date: Aug. 28, 2014

(54) BIOBASED NATURAL RUBBER COMPOSITION AND USE THEREOF

(71) Applicant: TESA SE, Hamburg (DE)

(72) Inventors: Tillmann Köpke, Pinneberg (DE); Julia Schwarzbach, Hamburg (DE); Guillaume Sandoz, Dardilly (FR)

(73) Assignee: TESA SE, Hamburg (DE)

(21) Appl. No.: 14/351,356

(22) PCT Filed: Oct. 19, 2012
(86) PCT No.: PCT/EP2012/070755

§ 371 Date: Apr. 11, 2014

(30) Foreign Application Priority Data
Oct. 26, 2011 (DE) 10 2011 085 223.9

(51) Int. Cl. C09J 7/02

(52) U.S. Cl. CPC C09J 7/0214
USPC 428/323; 524/77

(57) ABSTRACT

Pressure-sensitive adhesive composition which is biobased to the extent of 95% by weight, comprising natural rubber and tackifying resins of biobased raw material, and at least one biobased microparticulate additive which is insoluble in and does not crosslink with the base polymer or the tackifying resins.

This is a 371 of PCT/EP2012/062807 filed 2 Jul. 2012, which claims foreign priority benefit under 35 U.S.C. §119 of European Patent Application No. 11172623.8 filed Jul. 5, 2011.

The invention relates to the constitution of a biobased natural rubber composition and also to the use thereof.

### BACKGROUND OF THE INVENTION

Pressure sensitive adhesives (PSAs) are long-established. PSAs are adhesives which even under a relatively weak applied pressure permit a durable connection with the substrate and which after service can be detached from the substrate again substantially without residue. PSAs are permanently pressure-sensitively adhesive at room temperature, thus having sufficiently low viscosity and a high tack, meaning that they wet the surface of the respective substrate even under low applied pressure. The adhesive bonding capacity of the adhesives and their redetachability derive from their adhesive properties and from their cohesive properties. A variety of compounds are contemplated as a basis for PSAs.

Adhesive tapes furnished with PSAs, referred to as pressure sensitive adhesive tapes, are presently in diverse use within the industrial and household spheres. Pressure sensitive adhesive tapes consist typically of a carrier film, furnished on one or both sides with a PSA. There are also pressure sensitive adhesive tapes which consist exclusively of a layer of PSA and no carrier film, these being known as transfer tapes. The composition of the pressure sensitive adhesive tapes may vary very greatly and is dependent on the particular requirements of the various applications. The carriers typically consist of polymeric films, such as polypropylene, polyethylene, polyesters, for example, or else of paper, woven fabric, or nonwoven material.

The self-adhesives or PSAs consist typically of acrylate copolymers, silicones, natural rubber, synthetic rubber, styrene block copolymers, or polyurethanes.

In view of environmental aspects, sustainability, and against the background of the increasingly scarce crude oil resources, and, on the other hand, of a sharp increase worldwide in consumption of plastics, efforts have been underway for some years at producing plastics based on renewable raw materials. This is especially the case with biodegradable polymers, which are to be used in packaging applications or film applications. For medical applications as well, biodegradable products are playing an increasingly important role. A number of biobased or biodegradable plastics are available commercially at present.

Biobased means produced from renewable raw materials. Biodegradable polymers is a designation for natural and synthetic polymers which have properties similar to plastic (notched impact toughness, capacity for thermal plastification), but which unlike conventional plastics are degraded by a large number of microorganisms in a biologically active environment (compost, digested sludge, soil, wastewater); this does not necessarily happen under typical household conditions (garden composting). A definition of biodegradability is given in the European standards DIN EN 13432 (biodegradation of packaging) and DIN EN 14995 (compostability of plastics).

Natural rubber—as the name already indicates—is a biobased, elastic polymer which originates from plant products such as, in particular, latex.

Natural rubber is processed as an essential raw material into adhesives, referred to as natural rubber adhesives.

For the adjustment of application-relevant properties, PSAs may be modified by admixture of tackifier resins, plasticizers, crosslinkers, or fillers.

Fillers are used, for example, for increasing the cohesion of a PSA. In this context, it is frequently a combination of filler/filler interactions and filler/polymer interactions that leads to the desired strengthening of the polymer matrix.

Fillers are also admixed for increasing weight and/or volume in paper, plastics, and also adhesives and coating materials, and other products. The addition of filler often improves the technical usefulness of the products, and affects their quality—for example, strength, hardness, etc. The natural organic and inorganic fillers, such as calcium carbonate, kaolin, talc, dolomite, and the like, are produced mechanically.

With rubber and synthetic elastomers as well, suitable fillers can be used to improve the quality—for example, hardness, strength, elasticity, and elongation. Fillers in common use are carbonates, especially calcium carbonate, but also silicates (talc, clay, mica), siliceous earth, calcium sulfate and barium sulfate, aluminum hydroxide, glass fibers and glass beads, and carbon blacks.

Organic and inorganic fillers can also be distinguished according to their density. Accordingly, the inorganic fillers that are oftentimes used in plastics and also in adhesives, such as chalk, titanium dioxide, calcium sulfate, and barium sulfate, increase the density of the composite on account of the fact that their own density is higher than that of the polymer. For a given layer thickness, the weight per unit area is then higher.

Besides these, there are fillers which are able to reduce the overall density of the composite. They include hollow microbeads, highly bulky lightweight fillers. The beads are filled with air, nitrogen, or carbon dioxide; the shells of the beads consist of glass or else, in the case of certain products, of a thermoplastic.

In view of the fact that environmental aspects relating to the biobased factor are also playing an increasingly important role for pressure sensitive adhesive tapes, the skilled person is looking for adhesives whose individual constituents are as far as possible biobased. At the same time, however, it is very important that the properties of the adhesives and of the adhesive tapes produced using them do not suffer relative to those of the available, more biologically objectionable adhesives and adhesive tapes, respectively.

This also applies, in particular, to natural rubber-based adhesives, which on account of the rubber present in any case have a high biobased component.

It is an object of the invention to show a possible way in which PSAs based on natural rubber are amenable to technical applications, these PSAs exhibiting the same profile of properties as conventional PSAs and being biobased to as great an extent as possible.

### SUMMARY OF THE INVENTION

The invention accordingly relates to a pressure sensitive adhesive which is at least 95 wt %, preferably 98 wt %, biobased and comprises as its base polymer natural rubber and also tackifier resins composed of biobased raw materials, the fraction of the tackifier resins being 80 to 120 phr, and also at least one biobased microparticulate adjuvant which is insoluble in the base polymer or the tackifier resins and is noncrosslinking with the base polymer or the tackifier resins and which is in the form of particles and has a bulk density of at least 200 g/l, and in which at least 65%, preferably 90% to 95%, of the particles have a particle diameter of less than 32 μm, the fraction of the adjuvant relative to the overall pressure sensitive adhesive being between greater than 0 wt % and up to 20 wt %.

### DETAILED DESCRIPTON

The data given below in phr denote parts by weight of the relevant component per 100 parts by weight of all polymer components of the PSA (solids/solids), hence, for example, excluding the tackifier resins.

The wt % datum is always based on the composition of the overall PSA.

Moreover, with preference, it is possible for the natural rubber to be admixed, for the purpose of improving the processing qualities, with thermoplastic elastomers such as, for example, synthetic rubbers, with a fraction of up to 5 wt %.

Representatives that may be mentioned at this point include above all the particularly compatible styrene-isoprene-styrene (SIS) and styrene-butadiene-styrene (SBS) grades.

The natural rubber or natural rubbers may be selected in principle from all available quality grades such as, for example, crepe, RSS, ADS, TSR or CV grades, according to the required levels of purity and viscosity, and the synthetic rubber or synthetic rubbers may be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes and/or blends thereof.

The base polymer preferably consists of natural rubber; more preferably, indeed, besides natural rubber, there is no other polymer present in the PSA.

In that case the PSA is a composition composed of natural rubber, one or more tackifier resins, preferably aging inhibitor(s), and adjuvant within the limits stated in the main claim, and this represents a preferred embodiment. Additionally, furthermore, the fillers, dyes and/or aging inhibitors elucidated later on may be present optionally, in small quantities.

The term “tackifier resin” is understood by the skilled person to be a resin-based substance which increases the tackiness.

Tackifier resins composed of biobased raw materials are preferably polyterpene resins based on α-pinene and/or β-pinene and/or δ-limone or are terpene phenolic resins.

Any desired combinations of these may be used in order to bring the properties of the resultant PSA into line with requirements. Express reference may be made to the depiction of the state of knowledge in the “Handbook of Pressure Sensitive Adhesive Technology” by Donatas Satas (van Nostrand, 1989).

The amount by weight of the resins is 80 to 120 phr, preferably 90 to 100 phr, more preferably 100 phr.

For the purpose of setting optical and adhesive-bonding properties, the natural rubber-based PSA may comprise nonbiobased additives such as fillers, dyes, or aging inhibitors (antiozonants, antioxidants (primary and secondary), light stabilizers, etc.).

Additives to the adhesive that are customarily utilized are as follows:
primary antioxidants such as, for example, sterically hindered phenols
secondary antioxidants such as, for example, phosphites or thioethers
light stabilizers such as, for example, UV absorbers or sterically hindered amines

The fillers may be reinforcing or nonreinforcing. Deserving mention here in particular are silicon dioxides (spherical, acicular or irregular such as the pyrogenic silicas), calcium carbonates, zinc oxides, titanium dioxides, aluminum oxides, or aluminum oxide hydroxides. Once again it is expressly noted that these fillers, although they may occur naturally, are not considered in accordance with the invention to be among the biobased fillers.

The concentration of the additives which influence the optical and adhesive-bonding properties is up to 5 wt %.

In accordance with the invention, the fractions of all added substances such as synthetic rubbers and/or elastomers and/or fillers and/or dyes and/or aging inhibitors may not in total exceed 5 wt %, preferably 2 wt %.

The substances recited are not mandatory; the adhesive functions even if these substances, individually or in any desired combination, have not been added, in other words without synthetic rubbers and/or elastomers and/or fillers and/or dyes and/or aging inhibitors.

In accordance with the invention, up to 20 wt % is added of one or more biobased, microparticulate adjuvants in the form of particles, which have a bulk density of at least 200 g/l and for which at least 65% of the particles have a particle diameter of less than 32 μm.

The particle diameter is defined as the diameter in the case of virtually spherical particles, such as granular particles, for example, or the maximum length in the case of elongate particles, such as fibers, for example.

Biobased or organic fillers which can be used include, in particular, plant raw materials, and also animal raw materials, optionally also in combination with one another. The organic fillers are very preferably in finely divided form, more particularly in the form of fibers, meal, dust, or flour.

Plant organic fillers selected are preferably renewable raw materials (renewable organic materials), more particularly wood, cork, hemp, flax, grasses, reed, straw, hay, cereal, corn, nuts, or constituents of the aforementioned materials, such as shells (for example, nutshells), kernels, awns, or the like. Employed more particularly are wood flours, cork flours, cereal flours, corn flours and/or potato flours, without wishing for this recitation to imply unnecessary restriction on the inventive teaching.

Animal organic fillers advantageously employed include, in particular, bones, chitin (for example, crustacean shells, insect carapaces), hairs, bristles, and horn, more particularly in finely divided (ground) form.

Preferred as a filler is cellulose powder such as wood flour.

Employed with particular preference in accordance with the invention are the following cellulose powders:

Cellulose powders I with the following grain/fiber size distribution (figures each in wt %):
5% less than 100 μm, 95% less than 32 μm (sieve residue on Alpine air-jet sieve according to DIN EN ISO 8130-1)
bulk density 250 g/l
commercially available example: cellulose powder of type Jelucel HM 30 from JELU-WERK, Josef Ehrler GmbH & Co. KG;

Cellulose powders II with the following grain/fiber size distribution (figures each in wt %):
traces (<0.1%) less than 200 μm, 3% less than 150 μm, 30% less than 100 μm, about 67% less than 32 μm (sieve residue on Alpine air-jet sieve)
bulk density 220 g/l
commercially available example: cellulose powder of type Jelucel HM 90 from JELU-WERK, Josef Ehrler GmbH & Co. KG;

Cellulose powders III with the following grain/fiber size distribution (figures each in wt %):
traces (<0.1%) less than 200 μm, 5% less than 150 μm, 35% less than 100 μm, about 60% less than 32 μm (sieve residue on Alpine air-jet sieve)
bulk density 210 g/l
commercially available example: cellulose powder of type Jelucel HM 150 from JELU-WERK, Josef Ehrler GmbH & Co. KG;

The fraction of the organic fillers in the PSA is advantageously between 5 and 20 wt %, more particularly between 10 and 20 wt %, very particularly 12 and 16 wt %.

Particular advantage is associated with the use of organic fillers, more preferably from the group of the aforementioned fillers, whose bulk density is in the range from 210 to 300 g/l, preferably from 210 to 250 g/l.

The ignition residue of the fillers, more particularly of the cellulose powder, is preferably 0.3 wt % (based on the initial weight) and/or the drying loss is preferably 5 wt % (again based on the initial weight).

The PSA is utilized preferably for the furnishing of carriers, to give adhesive tapes.

Adhesive tapes in the sense of the invention are to comprehend all sheetlike or tapelike carrier formations coated on one or both sides with adhesive, hence including, in addition to conventional tapes, also labels, sections, diecuts (punched sheetlike carrier formations coated with adhesive), two-dimensionally extended structures (for example, sheets), and the like, including multilayer arrangements.

The expression “adhesive tape” further encompasses what are called “adhesive transfer tapes”, in other words an adhesive tape without carrier. In the case of an adhesive transfer tape, instead, the adhesive is applied between flexible liners prior to application, these liners being provided with a release layer and/or having antiadhesive properties. For the application, generally speaking, first one liner is removed, the adhesive is applied, and then the second liner is removed.

The adhesive tape may be provided in fixed lengths, such as in the form of product by the meter, for example, or else as continuous product on rolls (Archimedean spiral).

The coatweight (coating thickness) of the adhesive is preferably between 10 and 50 g/m², more preferably between 20 and 40 g/m², very preferably between 30 and 35 g/m².

Carrier materials used for the pressure sensitive adhesive tape are the carrier materials that are customary and familiar to the skilled person, such as paper, woven fabric, nonwoven, or films made, for example, of polyester such as polyethylene terephthalate (PET), polyethylene, polypropylene, oriented polypropylene, or polyvinyl chloride. Particular preference is given to using carrier materials composed of renewable raw materials such as paper, woven fabric made, for example, from cotton, hemp, jute, stinging nettle fibers, or films composed, for example, of polylactic acid, cellulose, modified starch, polyhydroxyalkanoate, biobased polypropylene, or biobased polyethylene. This recitation should not be understood as conclusive; instead, within the context of the invention, the use of other films is also possible.

The carrier material may be furnished preferably on one or both sides with the PSA.

The pressure sensitive adhesive tape is formed by application to the carrier, partially or over the whole area, of the adhesive. Coating may also take place in the form of one or more strips in lengthwise direction (machine direction), optionally in transverse direction (cross direction), but more particularly it is over the whole area. Furthermore, the adhesives may be applied in patterned dot format by means of screen printing, in which case the dots of adhesive may also differ in size and/or distribution, or by gravure printing of lines which join up in the lengthwise and transverse directions, by engraved-roller printing, or by flexographic printing. The adhesive may be in the form of domes (produced by screen printing) or else in another pattern such as lattices, stripes, or zigzag lines. Furthermore, for example, it may also have been applied by spraying, producing a more or less irregular pattern of application.

It is advantageous to use an adhesion promoter, referred to as a primer layer, between carrier and adhesive, or to use a physical pretreatment of the carrier surface in order to improve the adhesion of the adhesive on the carrier.

Primers which can be used are the known dispersion systems and solvent systems, based for example on isoprene- or butadiene-containing rubber, acrylate rubber, polyvinyl, polyvinylidene and/or cyclo rubber. Isocyanates or epoxy resins as additives improve the adhesion and in some cases also increase the shear strength of the PSA. The adhesion promoter may likewise be applied by means of a coextrusion layer on the one carrier film. Suitable physical surface treatments include, for example, flame treatment, corona or plasma, or coextrusion layers.

Furthermore, the carrier material, on the reverse or upper face, in other words opposite the adhesive side, may have been subjected to an antiadhesive physical treatment or coating, and more particularly may have been furnished with a parting or release agent (optionally blended with other polymers).

Examples are stearyl compounds (for example, polyvinylstearylcarbamate), stearyl compounds of transition metals such as Cr or Zr, ureas formed from polyethylenimine and stearyl isocyanate, or polysiloxanes. The term “stearyl” stands as a synonym for all linear or branched alkyls or alkenyls having a C number of at least 10 such as octadecyl, for example.

Suitable release agents further comprise surfactant-type release systems based on long-chain alkyl groups, such as stearyl sulfosuccinates or stearyl sulfosuccinamates, but also polymers which may be selected from the group consisting of polyvinylstearylcarbamates such as, for example, Escoat 20 from Mayzo, polyethylenimine-stearylcarbamides, chromium complexes of C₁₄ to C₂₈ fatty acids, and stearyl copolymers, as described in DE 28 45 541 A, for example. Likewise suitable are release agents based on acrylic polymers having perfluorinated alkyl groups, silicones based, for example, on poly(dimethylsiloxanes), or fluorosilicone compounds.

The carrier material may further be pretreated and/or aftertreated. Common pretreatments are hydrophobizing, customary aftertreatments are calendering, heating, laminating, punching, and enveloping.

The pressure sensitive adhesive tape may likewise have been laminated with a commercial release film or release paper, composed typically of a base material comprising polyethylene, polypropylene, polyester, or paper, which has a single-side or double-side polysiloxane coating.

The pressure sensitive adhesive film of the invention may be produced by customary coating methods known to the skilled person. In this context, the polyester PSA, including the additives, in solution in a suitable solvent, may be coated onto a carrier film or release film by means, for example, of engraved-roller application, comma bar coating, multiroll coating, or in a printing process, after which the solvent can be removed in a drying tunnel or drying oven. Alternatively, the carrier film or release film may also be coated in a solvent-free process. For this purpose, the copolyester is heated in an extruder and melted. Further operating steps may take place in the extruder, such as mixing with the additives described, filtration, or degassing. The melt is then coated using a slot die onto the carrier film or release film.

The pressure sensitive adhesive tape of the invention preferably has a bond strength to a steel substrate of at least 2.0 N/cm for a coatweight of 30 g/m². These values are also achieved after storage for 3 months at 23° C., 40° C. or 70° C.

Self-adhesive masking tapes, referred to below as adhesive masking tape, are required to exhibit a number of key properties in order to meet the particular requirements imposed on them. Without any claim to completeness being made, these requirements are a low thickness, a sufficient but not too high bond strength, the capacity for residue-free redetachment after the stresses of the actual application, effective adhesion of coating materials to the reverse, resistance to paint strikethrough, resistance to moisture, and a graduated bond strength to its own reverse.

The carrier material commonly used for adhesive masking tapes comprises mechanically creped papers, which are generally produced from 100% sodium kraft pulp. In the process known as wet creping, creping takes place generally in the paper machine with the aid of a creping doctor, on what is termed a creping cylinder either within or at the end of the press section or on one of the subsequent cylinders of the dry section. By compression of the paper web on the leading edge of the creping doctor while the paper is still wet and labile, microcreasing is produced in the paper. This highly sensitive process step generally limits the maximum possible speed of the paper machine, and shortens the length of the paper web by approximately 10% to 20%. In the course of the subsequent drying operation, the creases are fixed substantially by the formation of hydrogen bonds, and so, when the paper is mechanically stressed to a moderate extent in the lengthwise direction—such as occurs, for example, when an adhesive masking tape is unwound and a piece of appropriate length removed—the creases remain stable. The stability can be increased further by addition of sizing agents, and in this way adapted to the particular end use. It is normally determined by a stress/strain diagram measurement. In accordance with this process it is possible to produce flat crepe having machine-direction elongations at break of up to 20%. The cross-direction stretch is generally not more than about 5%.

Another process for producing stretchable paper carriers for adhesive masking tapes is that known as the CLUPAK process. Here, the fibers in the smooth paper are curled or compressed in the plane of the paper web by friction, by means of a destretching rubber cloth or rubber-coated rollers. The product is a stretchable paper whose curled fibers are extended again under tensile stress. No microcreasing is discernible; the paper appears smooth and is therefore not considered to be crepe paper in the true sense. A characteristic of the papers produced by this process is a tensile strength which is very high even under low stretch and which increases only slightly in the region of elongation at break. Normally, therefore, sized Clupak carriers without impregnation are used for adhesive masking tapes. The stretch obtained in machine direction is likewise up to 20%. With regard to this process and its product, reference may be made to DE 38 35 507 A1.

For achieving very high stretch levels of up to about 50%, the dry creping process is employed, as well as the conventional wet creping process, which for this purpose is operated with particularly coarse creping doctors. In the dry creping process, smooth paper is creped on a separate machine after remoistening with a binder solution (starch, CMC, PVAI), and then dried again. Both of these procedures produce what are known as high crepes, which as well as the extreme stretchability are notable for a high thickness and a very rough surface.

A further alternative for a creped carrier is disclosed in DE 103 16 995 A1. Furthermore, WO 2010/088322 A1 and DE 20 2010 005 924 U1 disclose advantageous, suitable paper carriers.

The adhesive tape is preferably furnished with one of the creped paper carriers described above, and used as a masking tape, such as in painting operations, for example. With particular advantage, the tape of the invention can be used by professional or home decorators in the outdoor area, such as when painting facades, in door or window work, and for other high-value decorating work, for example.

These painting operations may take place in a highly professional way in the automobile industry.

The adhesive tape of the invention with paper carrier is highly conforming, adheres outstandingly in spite of the biobased raw materials, more particularly the biobased fillers, and is also redetachable without residue. Furthermore, to temperatures of up to 60° C., the adhesive tape is temperature-stable, as measured by the “Temperature stability of adhesive tapes” method indicated below, on painted aluminum panels (metal black paint panels).

In particular, the adhesive tape shows no poorer properties than a comparable adhesive tape whose natural rubber-based adhesive has been blended with the conventional, nonbiobased tackifier resins or with the conventional, nonbiobased fillers such as, more particularly, calcium carbonate, as the examples show.

Further details, objectives, features, and advantages of the present invention will be elucidated in more detail below by reference to a number of figures which represent preferred working examples.

### BRIEF DESCRIPTION OF THE DRAWINGS

FIG. 1 shows a single-sided pressure sensitive adhesive tape,

FIG. 2 shows a double-sided pressure sensitive adhesive tape,

FIG. 3 shows a carrier-free pressure sensitive adhesive tape (adhesive transfer tape),

FIG. 4 shows the residue remaining in the area beneath the adhesive tape after the adhesive tape has been peeled from a test substrate in the Temperature Stability test,

FIG. 5 shows the residue remaining at the edges beneath the adhesive tape after the adhesive tape has been peeled from a test substrate in the Temperature Stability test.

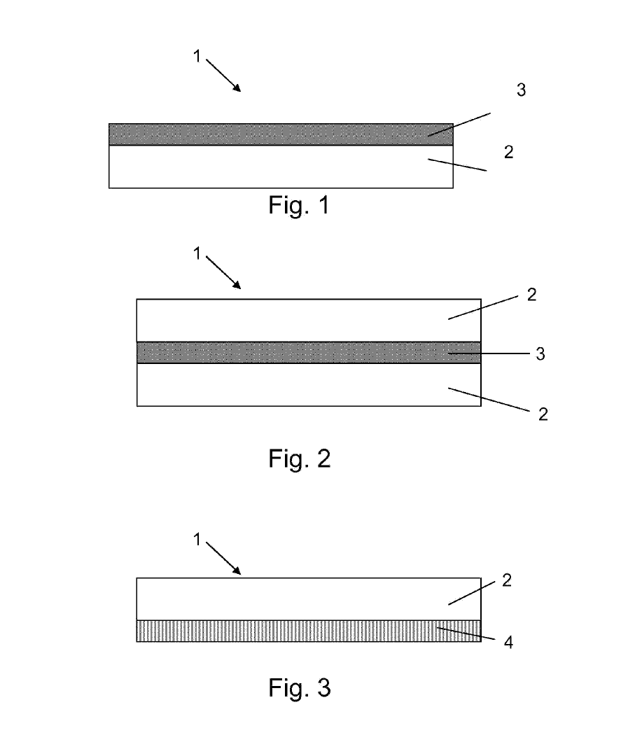

FIG. 1 shows a single-sidedly adhesive pressure sensitive adhesive tape (PSA tape) 1. The PSA tape 1 has an adhesive layer 2, produced by coating one of the above-described PSA onto a carrier 3. The PSA coatweight is preferably between 10 and 50 g/m².

Provided additionally (not shown) may also be a release film, which covers and protects the adhesive layer 2 before the PSA tape 1 is used. The release film is then removed before use from the adhesive layer 2.

The product construction shown in FIG. 2 shows a PSA tape 1 with a carrier 3, coated on both sides with a PSA and thus having two adhesive layers 2. The PSA coatweight per side is again preferably between 10 and 200 g/m².

With this embodiment as well, at least one adhesive layer 2 is preferably covered with a release film. In the case of a wound adhesive tape, this one release film may possibly also cover the second adhesive layer 2. However, it is also possible for a plurality of release films to be provided.

It is possible, furthermore, for the carrier film to be provided with one or more coatings. Moreover, only one side of the PSA tape may be equipped with the inventive PSA, and on the other side a different PSA may be used.

The product construction shown in FIG. 3 shows a PSA tape 1 in the form of an adhesive transfer tape, in other words a carrier-free PSA tape 1. For this construction, the PSA is coated single-sidedly onto a release film 4, thus forming a pressure-sensitively adhesive layer 2. The PSA coatweight here is usually between 10 and 50 g/m². This pressure-sensitively adhesive layer 2 is optionally further covered on its second side with a further release film. For the use of the PSA tape, the release films are then removed.

As an alternative to release films it is also possible, for example, to use release papers or the like. In that case, however, the surface roughness of the release paper ought to be reduced, in order to realize a PSA side that is as smooth as possible.

### Test Methods

Unless otherwise specified, the measurements are carried out under test conditions of 23±1° C. and 50±5% relative humidity.

### Determining the Fraction of Renewable Raw Materials

The fraction of renewable raw materials is determined in accordance with the ASTM D6866-04 C14 radiocarbon method. An alternative option is for the determination to take place arithmetically on the basis of manufacturer data for the raw materials.

### Bond Strength

The peel strength (bond strength) was tested in accordance with PSTC-1.

A strip of the PSA tape, 2 cm wide, is adhered to the test substrate, such as a steel plate, for example, by rolling it on back and forth five times using a 4 kg roller. The plate is clamped in, and the self-adhesive strip is peeled via its free end in a tensile testing machine under a peel angle of 180° and at a speed of 300 mm/min, with the force needed to achieve this being recorded. The results of measurement are reported in N/cm and are averaged over three measurements. The value is reported as BSS (bond strength to steel).

To determine the bond strength of an adhesive tape to its own reverse (BSRF, bond strength to reverse face), a test strip is placed, without being touched on its reverse, onto the test substrate, such as a steel plate, for example. A second test strip is then overlaid exactly onto the reverse face of the first strip, avoiding development of air inclusions, and is adhered by being rolled on back and forth five times using a 4 kg roller.

For the measurement, the upper test strip is peeled from that lying below it, at a peel angle of 180° and with a speed of 300 mm/min, and the force required to achieve this is recorded. The results of measurement are reported in N/cm and are averaged over three measurements.

### Rolling Ball Tack

The rolling ball tack was measured by the PSTC-6 method (Test Methods for Pressure Sensitive Adhesive Tapes, 15^{th} edition; publisher: Pressure Sensitive Tape Council, Northbrook (Ill.), USA), with the following modifications having been made:
Use of stainless steel ball bearings (stainless steel 1.4401), diameter 7/16 inch, mass 5.7 g
Bearing preparation: thorough cleaning with cellulose and acetone; the clean bearings are stored in an acetone bath for 15 minutes prior to the measurement series (bearings fully surrounded by the acetone); at least 30 minutes before the commencement of measurement, the bearings are removed from the acetone bath and stored open, for drying and conditioning, under standard conditions (23±1° C., 50±5% relative humidity)
Each bearing is used only for one measurement.

The tack was determined as follows: As a measure of the tack with a very short contact time, the rolling ball tack was measured. A strip of the adhesive tape approximately 30 cm in length was fastened horizontally to the test plane with the adhesive side upward, under tension. For the measurement, the steel bearing was accelerated under terrestrial gravity by rolling down a ramp with a height of 65 mm (angle of inclination: 21°). From the ramp, the steel bearing was steered directly onto the adhesive surface of the sample. The distance traveled on the adhesive by the bearing before reaching standstill was recorded. The roll travel length determined in this way is used here as an inverse measure of the tack of the self-adhesive (that is, the shorter the rolling distance, the higher the tack, and vice versa). The respective measurement value was obtained (as a reported length in mm) from the average value from five individual measurements on five different strips of each adhesive tape.

### Ignition Residue

The determination of the ignition residue is used for ascertaining the ash content of a substance, in other words the percentage inorganic fraction not combustible at 800° C. (glass fibers, glass beads, zinc oxide, titanium oxide, kaolin, etc.), based on the substance.

The ash content in percent is determined by differential weighing using an analytical balance (read-off accuracy 0.1 mg). For this purpose, first of all a microwave oven is heated to 800° C. in one hour and 10 minutes, and held at 800° C. for ten hours. Thereafter, quartz fiber crucibles (50 ml, Ø45 mm, height 30 mm) filled with the substance are placed in the oven, followed by ashing and ignition for 25 minutes.

The ash content in %, based on the substance, is calculated as follows:

$$ash = \frac{final mass \times 100}{initial mass}$$

At least two determinations are performed, and the arithmetic mean is calculated from the results.

### Drying Loss

The drying loss is determined in a similar way as for the ignition residue. For this purpose, first of all a microwave oven is heated to 100° C. in one hour, and held at 100° C. for two hours. Thereafter, quartz fiber crucibles (50 ml, Ø45 mm, height 30 mm) filled with the substance are placed in the oven, followed by ignition for three hours at 100° C. The drying loss is determined by differential weighing using an analytical balance (read-off accuracy 0.1 mg). The drying loss in wt %, based on the substance, is calculated.

$$drying loss = \frac{final mass \times 100}{initial mass}$$

At least two determinations are performed, and the arithmetic mean is calculated from the results.

### Temperature Stability of Adhesive Tapes

This test serves to ascertain the temperature stability of adhesive tapes. The test is for residues which may remain on the substrate after temperature exposure and subsequent demasking.

Two strips of the specimen under test are bonded to the specified substrate and subjected to the specified temperature loading.

Subsequently, one test strip, after thermal conditioning, in the warm state, is peeled off half at an angle of 90° and half at an angle of 180°, the second in the same way at room temperature.

Following peel removal, the substrate is examined for residues. The three test criteria of deposits, residues of composition in the area, and residues of composition at the edge are assessed according to rating scales.

For this test, painted aluminum panels (metal black paint panels) are typically used. In principle, however, it is also possible to use other substrates, examples being painted metal panels or plastics.

Before the test is conducted, the specimens under test and the test substrates must be conditioned at least overnight in a conditioning chamber. Test specimens with a width of more than 50 mm are cut to a width of 20 mm using a steel rule and cutters.

The substrates used for the test must be clean; unpainted areas are cleaned with suitable solvents prior to the test. Metal black paint panels are wiped with mineral spirit, plastic substrates with ethanol. After being cleaned, the substrate must stand for at least ten minutes for evaporation to take place.

At least two strips of the specimen under test are then adhered and pressed on thoroughly using a plastic doctor blade. The length of the strips ought not to be less than 25 cm. The test specimens are then exposed to the specified temperature loading. A typical duration is one hour. After storage, examination takes place to determine whether signs of detachment, shrinkage, or similar disruptions have occurred.

For peel removal in the “hot” state, the substrates, preferably metal panels, are conditioned at 60° C. in a forced-air oven for ten minutes.

Then one strip of each specimen is peeled off in the conditioning oven, this being the hot demasking. The strips are peeled half each at angles of 90° and 180°, rapidly and by hand (v=6 m/min).

After cooling has taken place for 15 minutes at room temperature, the second strip of the specimens is peeled off in the same way, this being the cold demasking.

After the individual test strips have been peeled off, the substrate is examined for deposits and residues of composition (see rating scales).

If tears occur during peel removal, this is reported by means of a rating scale as additional information with the result.

The three test parameters and any tears that have occurred are assessed for each of the four demasking conditions, in accordance with the following rating scales.

Deposits

| | |
|---|---|
| no deposits | B0 |
| very slightly visible deposits | B1 |
| slightly visible deposits | B2 |
| moderately visible deposits | B3 |
| highly visible deposits | B4 |
| very highly visible deposits | B5 |

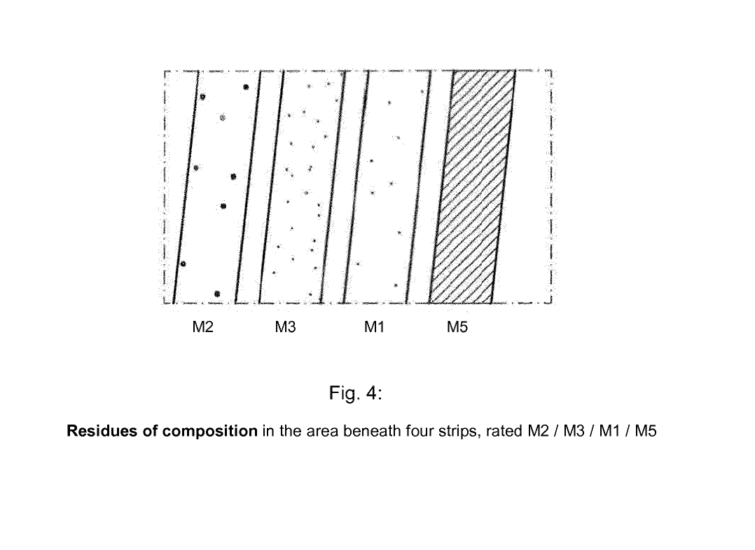

Residues of composition in the area (see FIG. 4)

| | |
|---|---|
| no residues of composition (RC) | M0 |
| minimal RC (small individual points) | M1 |
| slight RC (larger individual points) | M2 |
| moderate RC (many small points) | M3 |
| severe RC (many large points) | M4 |
| very severe RC (extensive residues) | M5 |

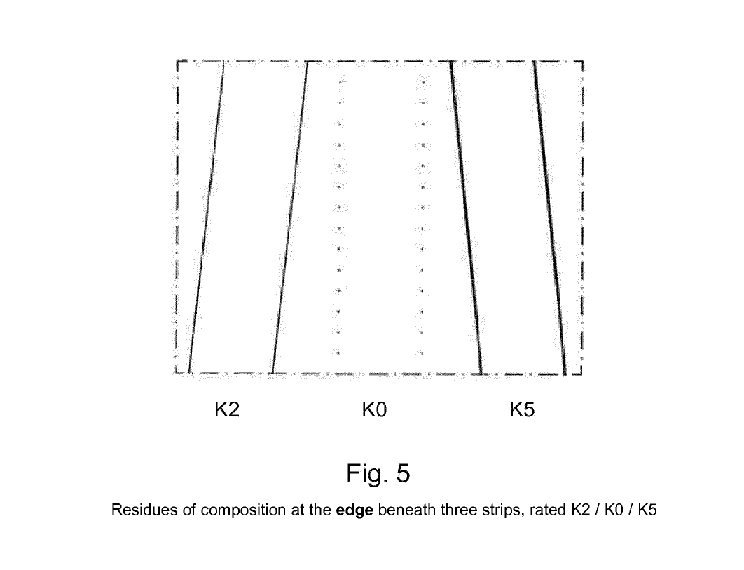

Edge (see FIG. 5)

| | |
|---|---|
| no edge | K0 |
| very slightly visible edge | K1 |
| slightly visible edge | K2 |
| moderately visible edge | K3 |
| highly visible edge | K4 |
| very highly visible edge | K5 |

Tears

| | |
|---|---|
| no tears | R0 |
| tendency to tear at peel angle of 180° | R1 |
| tears at 180°, o.k. at 90° | R2 |
| tendency to tear at 90° | R3 |
| tears at 90° | R4 |
| permanent tearing | R5 |

The ratings for deposits B and residues of composition in the area M and at the edge K are reported—if possible—for each of the four demasking conditions.

With the result, where appropriate, the ratings for tears R and any disruptions, such as detachment or shrinkage of the adhesive tape, for example, are also reported as additional information.

Furthermore, the level and duration of the temperature exposure, and the substrate used, are reported.

The intention of the text below is to elucidate the invention in more detail by reference to a number of examples, without thereby wishing to impose any unnecessary restriction on the invention.

### EXAMPLES

### Example 1

Batch size [g] 200
Solids content of composition [wt %] 30

| | Initial | | | |
|---|---|---|---|---|
| | mass of | Initial mass | | Initial wet |
| Raw material | solids [wt %] | of solids [g] | SC [%] | mass [g] |
| Natur V145 rubber | 41.90 | 83.80 | 100.00 | 83.80 |
| natural resin | 41.40 | 82.80 | 100.00 | 82.80 |
| JELUCEL HM 30 | 12.70 | 25.40 | 100.00 | 25.40 |
| NR powder premix 3 | 4.00 | 8.00 | 100.00 | 8.00 |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was an α-pinene-based terpene resin (Dercolyte A 115). Powder premix 3 consists of 50 wt % chalk, 25 wt % TiO₂, and 25 wt % aging inhibitors.

### Example 2

Batch size [g] 200
Solids content of composition [wt %] 30

| | Initial | | | |
|---|---|---|---|---|
| | mass of | Initial mass | | Initial wet |
| Raw material | solids [wt %] | of solids [g] | SC [%] | mass [g] |
| Natur V145 rubber | 41.90 | 83.80 | 100.00 | 83.80 |
| natural resin | 41.40 | 82.80 | 100.00 | 82.80 |
| JELUCEL HM 30 | 12.70 | 25.40 | 100.00 | 25.40 |
| NR powder premix 3 | 4.00 | 8.00 | 100.00 | 8.00 |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was a β-pinene-based terpene resin (Dercolyte S 115).

### Example 3

Batch size [g] 200
Solids content of composition [wt %] 30

| | Initial mass of | Initial mass | | Initial wet |
|---|---|---|---|---|
| Raw material | solids [wt %] | of solids [g] | SC [%] | mass [g] |
| Natur V145 rubber | 41.90 | 83.80 | 100.00 | 83.80 |
| natural resin | 41.40 | 82.80 | 100.00 | 82.80 |
| JELUCEL HM 30 | 14.70 | 29.40 | 100.00 | 29.40 |
| NR premix 4 | 2.00 | 4.00 | 100.00 | 4.00 |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was an α-pinene-based terpene resin (Dercolyte A 115). Premix 4 consists of 50 wt % TiO₂, 12.5 wt % 2-mercaptobenzimidazole (from Lanxess), and 37.5 wt % aging inhibitors.

### Example 4

Batch size [g] 200
Solids content of composition [wt %] 30

| | Initial | | | |
|---|---|---|---|---|
| | mass of | Initial mass | | Initial wet |
| Raw material | solids [wt %] | of solids [g] | SC [%] | mass [g] |
| Natur V145 rubber | 41.90 | 83.80 | 100.00 | 83.80 |
| natural resin | 41.40 | 82.80 | 100.00 | 82.80 |
| JELUCEL HM 90 | 14.70 | 29.40 | 100.00 | 29.40 |
| NR powder premix 3 | 2.00 | 4.00 | 100.00 | 4.00 |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was a β-pinene-based terpene resin (Dercolyte S 115).

### Example 5

Batch size [g] 200
Solids content of composition [wt %] 30

| | Initial mass of | Initial mass | | Initial wet |
|---|---|---|---|---|
| Raw material | solids [wt %] | of solids [g] | SC [%] | mass [g] |
| Natur V145 rubber | 44.76 | | 100.00 | |
| natural resin | 37.39 | | 100.00 | |
| JELUCEL HM 30 | 15.71 | | 100.00 | |
| NR premix 4 | 2.14 | | 100.00 | |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was an α-pinene-based terpene resin (Dercolyte A 115).

Premix 4 consists of 50 wt % TiO₂, 12.5 wt % 2-mercaptobenzimidazole (from Lanxess), and 37.5 wt % aging inhibitors.

### Example 6

Batch size [g] 200
Solids content of composition [wt %] 30

| | Initial | | | |
|---|---|---|---|---|
| | mass of | Initial mass | | Initial wet |
| Raw material | solids [wt %] | of solids [g] | SC [%] | mass [g] |
| Natur V145 rubber | 38.26 | | 100.00 | |
| natural resin | 43.99 | | 100.00 | |
| JELUCEL HM 30 | 15.62 | | 100.00 | |
| NR powder premix 3 | 17 2.13 | | 100.00 | |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The natural resin employed was an α-pinene-based terpene resin (Dercolyte A 115).

### Comparative Example

Batch size [g] 200
Solids content of composition [wt %] 30

| | Initial | | | |
|---|---|---|---|---|
| | mass of | Initial mass | | Initial wet |
| Raw material | solids [wt %] | of solids [g] | SC [%] | mass [g] |
| Natur V145 rubber | 41.90 | 83.80 | 100.00 | 83.80 |
| resin | 41.40 | 82.80 | 100.00 | 82.80 |
| chalk | 12.70 | 25.40 | 100.00 | 25.40 |
| NR powder premix 3 | 4.00 | 8.00 | 100.00 | 8.00 |
| total | 100.00 | 200.00 | | 200.00 |
| solvent | | | | |
| mineral spirit | | | | 466.67 |

| | |
|---|---|
| Overall mass | 666.67 |

Preparation procedure:
Place ⅓ of the mineral spirit in the compounder for preliminary swelling
Introduce 100% of the rubber quantity
Introduce 100% of the filler quantity
Introduce 100% of the premix quantity
Leave to stand from the date of weighing to the next morning (to swell)
Kneading procedure:
Switch on prepared compounder contents and knead for 5 minutes
Add the weighed and mortared resin in 4 portions (within 1 hour)
Within 1 hour, add the remaining ⅔ of the solvent, in portions, and knead.
Leave to knead for 15 minutes
Total run time about 2.25 hours

The resin employed was a Piccotac 1100E (aliphatic O₅ hydrocarbon resin).

### Results

The adhesives prepared according to the process described were coated at 40 g/m² onto a crepe paper carrier with a carrier weight of 64 g/m² (40 g of paper with a 16 g impregnation, 6 g of paint on the top face and 2 g of adhesion promoter on the bottom face; based in each case on one square meter).

| | | Comp. Ex. | | |
|---|---|---|---|---|
| | | Standard | Ex. 1 | Ex. 2 |
| BSS | [N/cm] | 2.71 | 2.67 | 3.43 |
| BSRF | [N/cm] | 1.24 | 1.00 | 0.98 |
| Temperature stability | | h: B1 | h: o.k. | h: B2, K1, |
| (1 h @ 60° C.) | | c: B3, M1 | c: M1 | M1 |
| | | K1 | | c: B2, K1, |
| | | | | M2, R2 |
| Rolling Ball Tack | | 100 | 59.4 | >250 |
| (mm) | | | | |
| | | Comp. Ex. | | |
| | | Standard | Ex. 3 | Ex. 4 |
| BSS | [N/cm] | 2.71 | 2.13 | 2.41 |
| BSRF | [N/cm] | 1.24 | 0.80 | 0.81 |
| Temperature stability | | h: B1 | h: o.k. | h: K1, |
| (1 h @ 60° C.) | | c: B3, M1 | c: B1, K1 | M1 |
| | | K1 | M2 | c: K1, M1 |
| Rolling Ball Tack | | 100 | 49.8 | 29 |
| (mm) | | | | |
| | | Comp. Ex. | | |
| | | Standard | Ex. 5 | Ex. 6 |
| BSS | [N/cm] | 2.71 | 1.32 | 2.47 |
| BSRF | [N/cm] | 1.24 | 0.50 | 0.75 |

| | | | |
|---|---|---|---|
| Temperature stability | h: B1 | h: o.k. | h: B1, M1 |
| (1 h @ 60° C.) | c: B3, M1 | c: B2, K1 | c: B2, M3 |
| | K1 | M1 | |
| Rolling Ball Tack | 100 | 55.6 | >167.4 |
| (mm) | | | |

The temperature stability was determined on clearcoat-painted metal panels in an oven at 60° C. for one hour.

The meanings of the abbreviations are as follows:

h peeled off hot
c peeled off cold
B deposit
K edge formation
M visual residue of composition.
For ratings see above

1. A pressure sensitive adhesive which is at least 95 wt %, biobased and comprises as its base polymer natural rubber and also tackifier resins composed of biobased raw materials, the fraction of the tackifier resins being 80 to 120 phr, and also at least one biobased microparticulate adjuvant which is insoluble in the base polymer or the tackifier resins and is noncrosslinking with the base polymer or the tackifier resins and which is in the form of particles and has a bulk density of at least 200 g/l, and in which at least 65% of the particles have a particle diameter of less than 32 μm, the fraction of the adjuvant relative to the overall pressure sensitive adhesive being between greater than 0 wt % and up to 20 wt %.

2. The pressure sensitive adhesive as claimed in claim 1, wherein
the pressure sensitive adhesive is at least 98 wt % biobased.

3. The pressure sensitive adhesive as claimed in claim 1,
wherein
the base polymer is natural rubber only, and there is no further polymer present in the pressure sensitive adhesive.

4. The pressure sensitive adhesive as claimed in claim 1, wherein
the tackifier resins are polyterpene resins of α-pinene and/or β-pinene and/or δ-limone or are terpene phenolic resins.

5. The adhesive as claimed in
claim 1, wherein
the fraction of the tackifier resins is 90 to 100 phr.

6. The adhesive as claimed in
that claim 1, wherein the adhesive comprises biobased or organic fillers in the amount of between 5 and 20 wt %.

7. The adhesive as claimed in
claim 6, wherein the biobased or organic fillers are plant and/or animal raw materials.

8. The adhesive as claimed in
claim 1, wherein
the pressure sensitive adhesive comprises only natural rubber, tackifier resin(s), aging inhibitor(s), and adjuvant.

9. A single- or double-sided adhesive tape comprising the pressure-sensitive adhesive of claim 1.

10. The single- or double-sided adhesive tape of claim 9, wherein, the coatweight (coating thickness) of the adhesive is between 10 and 50 g/m².

11. The single- or double-sided adhesive tape of claim 9, wherein said adhesive tape is a single-sided adhesive masking tape for the temporary covering of a substrate.
